(19) United States
(12) Patent Application Publication
(10) Pub. No.: US 2003/0126231 A1
(43) Pub. Date: Jul. 3, 2003

(54) System and method for reprocessing web contents in multiple steps

(76) Inventors: Min Su Jang, Daejeon (KR); Joo Chan Sohn, Daejeon (KR); Jong Myung Baik, Daejeon (KR)

Correspondence Address: JACOBSON HOLMAN PLLC, 400 SEVENTH STREET N.W., SUITE 600, WASHINGTON, DC, 20004, US

(21) Appl. No.: 10/195,516

(22) Filed: Jul. 16, 2002

(30) Foreign Application Priority Data
Dec. 29, 2001 (KR) 2001-88365

(51) Int. Cl. G06F 15/16

(52) U.S. Cl. 709/218; 709/203

(57) ABSTRACT

A system and a method for reprocessing web contents in multiple steps are disclosed. A user agent generates an HTTP request message in response to an user's demand and transmits the HTTP request message. A web server analyzes the HTTP request message transmitted from the user agent and generates a contents requested by the user to thereby transmit the contents to a corresponding intermediate server which performs multi-step reprocessing of the contents. And a plurality of intermediate servers reprocesses the contents transmitted from the web server and transmits the contents to the user agent.

### FIELD OF THE INVENTION

The present invention relates to an Internet transfer protocol HTTP(hypertext transfer protocol) and a service of reprocessing web contents transmitted by using the HTTP; and, more particularly, to a system and a method for reprocessing web contents by making a plurality of servers process the web contents in multiple steps.

### BACKGROUND OF THE INVENTION

Typically, the HTTP is an application-level protocol related to TCP/IP, which is standardized to make it possible to transmit a text, a graphic image, a sound, a video and other multimedia files on the web.

In FIG. 1, there is illustrated a basic processing structure of a prior art HTTP protocol. The HTTP operates by using a pair of a request and a respond. That is, an user agent(UA) 100 sends a request, and an origin server(OS) 102 sends a response for the request. At this time, the OS 102 checks the HTTP request message, which is transmitted from the UA 100, to determine what the UA 100 requests, and transmits the requested contents. That is to say, the prior art HTTP can operate a simple request-respond processing, in which only the UA 100 and the OS 102 are involved, as illustrated in FIG. 1. In this process, multiple servers do not work together for multi-step reprocessing a single HTTP transaction. Consequently, this can not satisfy various demands of user using web contents.

FIG. 2 describes a processing structure of HTTP protocol having more complicate structure than the prior art HTTP processing structure which has only the UA and OS. According to HTTP/1.1 standard, three kinds of intermediaries can be located between the UA 100 and the OS 102. The intermediaries are a tunnel 204, a proxy server 202 and a gateway 206 as shown in FIG. 2. These are located between the UA 100 and the OS 102, and relay the messages which are interchanged between the UA 100 and the OS 102. To put in detail, the proxy server 202 receives an HTTP request message from the UA 100 and modifies a content of the HTTP request message partially. And then, the proxy server 202 transmits the HTTP request message to a server indicated by a request URI in the HTTP request message. Accordingly, the proxy server 202 acts as a cache server. The gateway 206 receives an HTTP request message directed to the OS 102, processes a predetermined operation for the request message, and thereafter transmits the message to the OS 102. Contrary to the proxy server 202, the gateway 206 is a server belonging to the OS 102, and is designed so that all HTTP request messages transmitted thereto are to be retransmitted to the OS 102. A firewall or a reverse proxy can be used as the gateway. The tunnel 204 is located between the UA 100 and the OS 102, and simply passes the HTTP message therethrough. Hence the tunnel 204 acts as a part of the gateway 206. For example, if a message transmitted from the specific UA 100 is configured to go through a firewall, the firewall can include therein a tunnel such as the tunnel 204.

Even though the intermediaries, such as the proxy server 202, the tunnel 204 and the gateway 206, can be employed in the HTTP structure as shown in FIG. 2, the intermediaries just play a role to relay message to be interchanged between the UA 100 and the OS 10. Accordingly, like as the HTTP structure shown in FIG. 1, multiple servers do not work together for multi-step reprocessing a single HTTP transaction in the HTTP processing structure shown in FIG. 2.

### SUMMARY OF THE INVENTION

It is, therefore, an object of the present invention to provide a system and a method for converting web contents into various type of contents by processing the web contents in multiple steps.

In accordance with one aspect of the invention, there is provided A system for reprocessing web contents in multiple steps, comprising: an user agent(UA) for generating an HTTP request message in response to an user's demand and transmitting the HTTP request message; a web server for analyzing the HTTP request message transmitted from the user agent and generating a contents requested by the user to thereby transmit the contents to a corresponding intermediate server which performs multi-step reprocessing of the contents; and a plurality of intermediate servers for reprocessing the contents transmitted from the web server and transmitting the contents to the user agent.

In accordance with another aspect of the invention, there is provided A method for reprocessing web contents in multiple steps in a system having an user agent, a web server and a plurality of intermediate servers for multi-step reprocessing of the web contents, comprising the steps of: (a) generating a requested web contents in response to an HTTP request message transmitted from the user agent; (b) examining whether a multi-step reprocessing of the web contents has been requested; (c) requesting the multi-step reprocessing the plurality of intermediate servers by transmitting the web contents thereto the multiple intermediate servers if the multi-step reprocessing of the web contents has been requested; and (d) transmitting the web contents reprocessed by the plurality of intermediate servers to the user agent.

### BRIEF DESCRIPTION OF THE DRAWINGS

The above and other objects and features of the present invention will become apparent from the following description of preferred embodiments given in conjunction with the accompanying drawings, in which:

FIGS. 1 and 2 show network configurations using conventional HTTP processing methods;

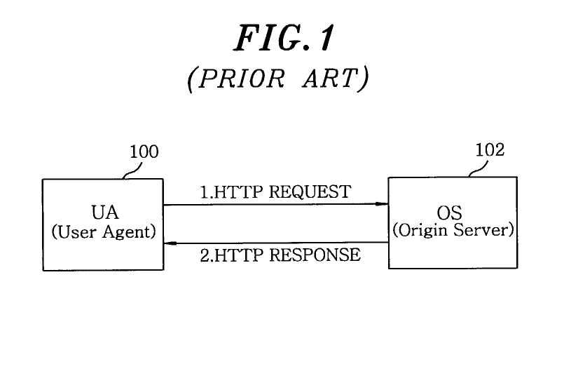

FIG. 3 describes a system using an HTTP processing method in accordance with a preferred embodiment of the present invention;

FIG. 4 illustrates an example of a server map including a list of multiple intermediate servers in accordance with a preferred embodiment of the present invention;

FIG. 5 offers a flowchart showing an operation of multi-step reprocessing web contents in accordance with another preferred embodiments of the present invention.

### DETAILED DESCRIPTION OF THE PREFERRED EMBODIMENTS

The preferred embodiments of the present invention will now be described in detail with reference to the accompanying drawings.

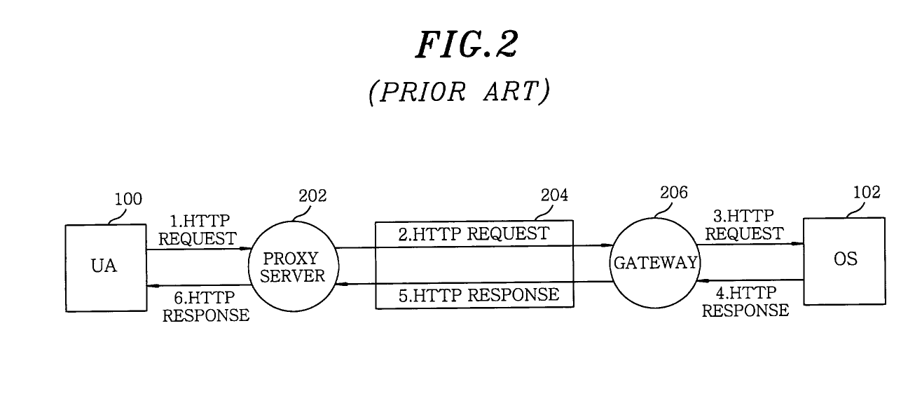

FIG. 3 illustrates a system in which multiple servers work together for a single HTTP transaction and performs multi-step reprocessing the HTTP transaction in accordance with a preferred embodiment of the present invention.

As shown in FIG. 3, in this embodiment, a response message for a HTTP request, which is transmitted from an UA 300 is reprocessed in multiple steps by passing an OS 302 and intermediate severs(ISs) 304 and 306. For this operation, the HTTP request message has a server map for the multiple intermediate servers, such that a corresponding web server conceives a corresponding intermediate message included in the server map to process it.

The server map includes a list of information on reprocessing of contents. There are several methods to describe a contents reprocessing service, but generally, URI information of an intermediate server is included in the server map. Meanwhile, a user of the UA configures the list of the contents reprocessing services according to any one of the methods. In this case, the user can make as many server maps as he or she wants. Also, the user can select a different server map to each of the contents, respectively.

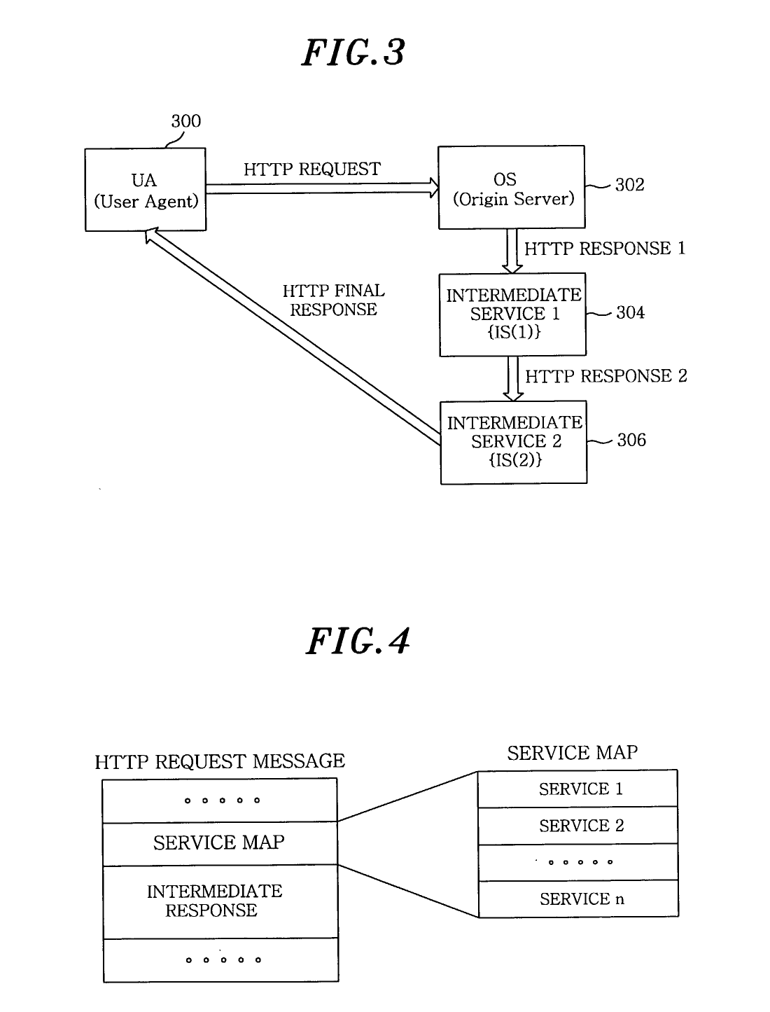

FIG. 4 presents a conceptional structure of the server map included in an HTTP request message. As shown in FIG. 4, the server map is configured in the form of a table describing contents reprocessing services in order. The server map can be inserted in an HTTP message by employing several methods. One of the methods is to include the server map in a header area of the HTTP message or insert it in a body of the HTTP message in XML document format.

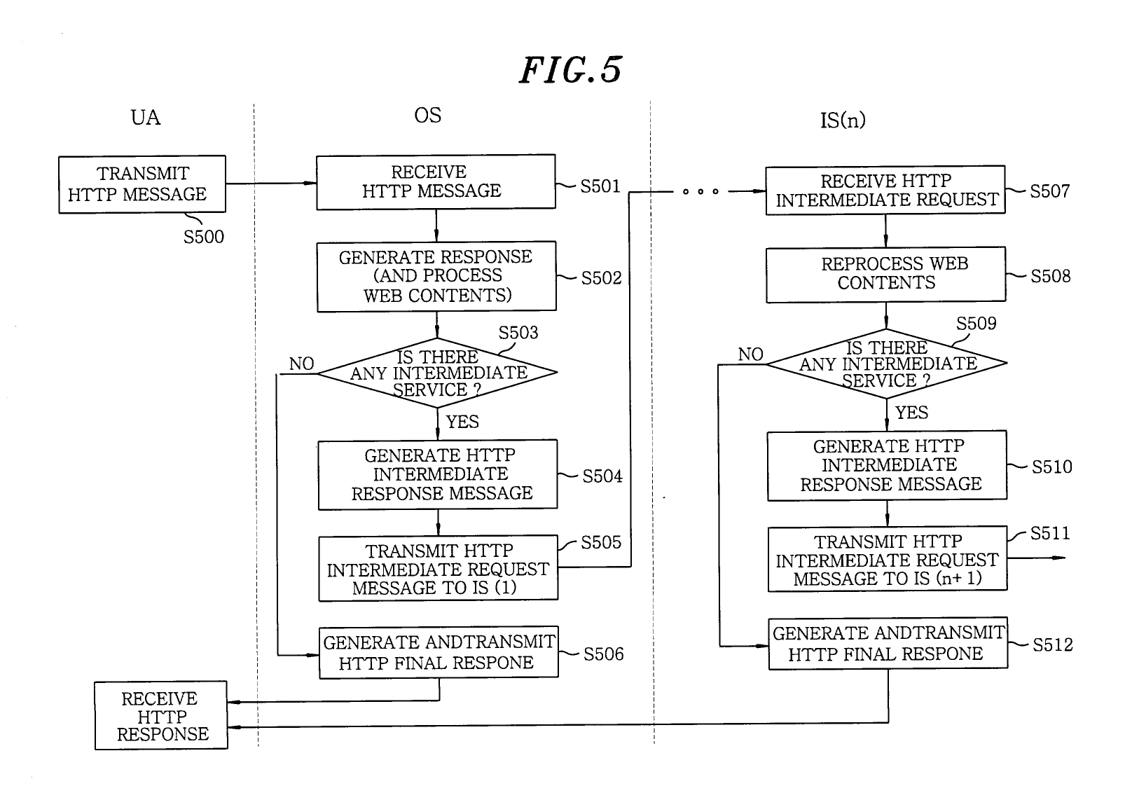

FIG. 5 offers a flowchart showing a method for an HTTP intermediate processing in which multiple servers work together for multi-step reprocessing for a single HTTP transaction in accordance with another preferred embodiment of the present invention. The detailed description on the preferred embodiment of the present invention will be given with reference to FIGS. 3 to 5.

In step S500, the UA 300 transmits an HTTP message to the OS 302. And then, the OS 302 receives the HTTP message and generates a response for the HTTP message likewise a conventional web server does (steps S501 and S502).

In the step 502, the OS 302 generates or extracts a source of the contents being indicated by an URI requested by the UA 300. Thereafter, in step 503, the OS 302 examines whether a list of intermediate services is included in HTTP request message. If the list is not found in the HTTP request message, the OS 302 generates an HTTP response message and transmits it to the UA 300 (step S506).

Otherwise, i.e., if the list is found in the step S503, the OS 302 generates an HTTP intermediate request message (S504). And then, the OS 302 transmits the HTTP intermediate request message to the next intermediate server IS(n) included in the list (step S505). As described before, this HTTP intermediate request message has same format as a conventional HTTP message except that web contents and a server map are inserted into the body of the HTTP intermediate request message in accordance with the preferred embodiment of the present invention.

In step S507, the IS(n) receives the HTTP intermediate request message. And then, in steps S508 to S512, the IS(n) performs the same processing steps as those which the OS 302 performs to process the HTTP message transmitted from the UA 300. Consequently, multiple servers work together to reprocess a single HTTP transaction and in multi-steps.

While the invention has been shown and described with respect to the preferred embodiments, it will be understood by those skilled in the art that various changes and modifications may be made without departing from the spirit and scope of the invention as defined in the following claims.

What is claimed is:

1. A system for reprocessing web contents in multiple steps, comprising:
a user agent(UA) for generating an HTTP request message in response to a user's demand and transmitting the HTTP request message;
a web server for analyzing the HTTP request message transmitted from the user agent and generating a contents requested by the user to thereby transmit the contents to a corresponding intermediate server which performs a multi-step reprocessing of the contents; and
a plurality of intermediate servers for reprocessing the contents transmitted from the web server and transmitting the contents to the user agent.

2. The system of claim 1, wherein the HTTP request message includes information on a list of the plurality of intermediate servers which the user has selected for multi-step reprocessing of the contents.

3. The system of claim 2, wherein the list of the intermediate servers is included in a header area of the HTTP request message.

4. The system of claim 2, wherein the list of the intermediate servers is included in a data area of the HTTP request message in the form of a XML document.

5. The system of claim 2, wherein, if the user has requested multi-step reprocessing of the contents, the web server selects a next intermediate server based on a priority which is determined with reference to the list of the intermediate servers and generates an HTTP intermediate request message including the contents to thereby transmit the HTTP intermediate request message to the next intermediate server.

6. The system of claim 5, wherein the HTTP intermediate request message includes the contents in a data area thereof, the contents being reprocessed in the next intermediate server.

7. The system of claim 6, wherein the HTTP intermediate request message includes information on a list of a plurality of intermediate servers which the user has selected for multi-step reprocessing of the contents.

8. The system of claim 2, wherein, if there is no remaining intermediate server for reprocessing the contents in the list of intermediate servers, the intermediate server transmits the reprocessed contents to the user agent.

9. A method for reprocessing web contents in multiple steps in a system having an user agent, a web server and a plurality of intermediate servers for multi-step reprocessing of the web contents, comprising the steps of:
(a) generating a requested web contents in response to an HTTP request message transmitted from the user agent;
(b) examining whether a multi-step reprocessing of the web contents has been requested;
(c) requesting the multi-step reprocessing to the plurality of intermediate servers by transmitting the web contents thereto if the multi-step reprocessing of the web contents has been requested; and
(d) transmitting the web contents reprocessed by the plurality of intermediate servers to the user agent.

10. The method of claim 9, wherein the step (a) includes the steps of:
(a1) receiving the HTTP request message from the user agent; and
(a2) analyzing the HTTP request message and generating the web contents requested by the user agent.

11. The method of claim 9, wherein the HTTP request message includes information on a list of the intermediate servers which the user has selected for multi-step reprocessing of the web contents.

12. The method of claim 11, wherein the list is included in a header area of the HTTP request message.

13. The method of claim 11, wherein the list is included in a data area of the HTTP request message in the form of XML document.

14. The method of claim 9, wherein the step (c) includes the steps of:
(c1) selecting a next intermediate server determined with respect to the list of intermediate servers included in the HTTP request message;
(c2) generating an HTTP intermediate request message including the web contents to be reprocessed; and
(c3) requesting the multi-step reprocessing of the web contents to the next intermediate server by transmitting the HTTP intermediate request message thereto.

15. The method of claim 14, wherein the HTTP intermediate request message includes web contents in a data area thereof, the web contents being reprocessed in the next intermediate server.

16. The method of claim 15, wherein the HTTP request message includes information on a list of a plurality of intermediate servers which the user has selected for multi-step reprocessing of the web contents.

17. The method of claim 14, wherein, if there is no remaining intermediate server for reprocessing the web contents in the list of intermediate servers in the step (e), the step (c) further comprising the step of;
(c4) transmitting the reprocessed web contents to the user agent.
